(19) United States
(12) Patent Application Publication
(10) Pub. No.: US 2009/0126240 A1
(43) Pub. Date: May 21, 2009

(54) Method, Device and Apparatus for Delivering Promotion and Advertising

(75) Inventors: Phin Thjai, New South Wales (AU); John Dekker, New South Wales (AU)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Lid Power Pty Limited, Roseville (AU)

(21) Appl. No.: 11/886,865

(22) PCT Filed: Oct. 26, 2005
(86) PCT No.: PCT/AU2005/001651

§ 371 Date: Dec. 22, 2008

(30) Foreign Application Priority Data
Mar. 22, 2005 (AU) 2005201237

(51) Int. Cl. G09F 3/00; B65B 7/28; B65B 5/10

(52) U.S. Cl. 40/299.01; 53/312; 156/573; 156/379; 53/244

(57) ABSTRACT

The present invention relates to a method and system for delivering messages, such as advertising messages. Printed labels are provided on drinks container lids, such as takeaway coffee container lids. Providing printed labels has the advantage that the lid does not need to be changed to provide a different message. Only the printed label has to be changed.

To facilitate placement of the printed labels on the lids, the present invention also provides a labelling machine which includes delivery apparatus for delivering lids to a labelling position. The delivery apparatus includes a picker arrangement arranged to pick individual lids from a magazine and place them on a conveyer for delivery to the labelling point. It also includes a stacker apparatus for stacking the lids into a magazine for ease of distribution.

### FIELD OF THE INVENTION

The present invention relates to a method, device and apparatus for delivering promotion or advertising, and, more particularly, but not exclusively, to a method and system for delivering promotional or advertising messages via the lids of drink containers.

### BACKGROUND OF THE INVENTION

Advertising and other messages are delivered in many ways, via many different types of media. It is known to deliver messages by way of including a message on a drinks-cup lid, or a takeaway drinks container. The messages are applied to the drinks-cup lid by moulding the lids so that the message appears indented or raised on the drinks-cup lid. Note that these drinks-cup lids are generally of plastics material, although they may also be of paper material.

It is, however, quite expensive to provide messages in this way. Only one message can be provided per moulding. To change the message, different mouldings have to be used. This increases costs, which will usually be borne by the purchaser of the lids e.g. coffee shop owner. Because of this, this form of message delivery has to date found only limited application.

### SUMMARY OF THE INVENTION

In accordance with a first aspect, the present invention provides a method for delivering promotion or advertising, comprising the steps of providing a drinks container lid having a printed label on the top surface thereof, the printed label including promotional or advertising information.

In one embodiment, the drinks container lid is of the type which is arranged to act as a lid for a cup-like container, such as, for example, a takeaway coffee drinks container. In this case, the container is in the form of a cup, and the lid covers the mouth of the cup.

In one embodiment, the printed label may cover the majority of the portion of the top surface of the lid. Where the lid is of the type which has a raised rim and an indented central portion, the printed label may cover the indented central portion.

In one embodiment, the printed label is adhered to the top of the lid by some means, for example, adhesive.

In one embodiment, the printed label is a single layer label having means for adhering on the bottom of the label and the promotional or advertising information on the top of the label.

In one embodiment, the label includes a removable section.

In one embodiment, the lid is a lid for a takeaway coffee container.

An advantage of an embodiment of the invention is that to change the advertising or promotional information it is only necessary to change the printed label, and it is not necessary to change the drinks container lid, for example it is not necessary to remould the drinks container lid. Any appropriate drinks container lids can therefore be used consistently, and advertising messages can be changed by affixing printed labels having different messages. Advertising campaigns can therefore be delivered without it being necessary to change the configuration of the container lid.

In one embodiment, the printed label is affixed in a predetermined orientation on the container lid. This has the advantage that any information provided on a printed label will be at a predetermined orientation on the lid and therefore predetermined orientation to the user and when user is drinking through e.g. a spout that may be provided on the lid. In one embodiment, where the lid has a spout or other passageway or hole for fluid to pass through, the predetermined orientation of the printed label may be at a predetermined orientation with respect to the spout or other exit. In one embodiment, the predetermined orientation may be such that a user can easily read the matter when the spout or exit is directed towards them.

In accordance with a second aspect, the present invention provides a device for delivering a message, the device comprising a drinks container lid having a printed label on the top surface thereof, which includes promotional or advertising information.

In accordance with a third aspect, the present invention provides a printed label for a drinks container lid, the printed label being arranged to be affixed to the top of the drinks container lid, and the printed label bearing promotional or advertising material.

In one embodiment, the printed label includes a removable section.

In one embodiment, the printed label is of a size to substantially cover over fifty percent of the top surface of the lid. In one embodiment, where the lid is of the type which has a raised border and lowered central portion, the printed label is of a size which covers the lowered central portion.

The applicants have designed an apparatus for applying printed labels to drinks container lids. In order to facilitate the labelling process, the applicants have discovered that one of the important aspects is the delivery of lids to a labelling station. Handling delivery of the types of lids which are used for drinks containers can be quite difficult. The plastics and paper type lids are quite light and difficult to handle and place. To do this manually would not be cost effective.

In accordance with a fourth aspect, the present invention provides a delivery apparatus for delivering drinks container lids to a labelling station for labelling with printed labels, the delivery apparatus including a picker arrangement arranged to carry out an operation involving picking a single lid from a magazine arranged to contain a plurality of lids and placing the lid on a conveyer means for conveying the lid to the labelling station, the picker arrangement being arranged to carry out the operation repetitively to continue to place single lids on the conveyer means.

In one embodiment, the picker arrangement includes a picker head which is arranged to grab a lid from the magazine, and picker arm attached to the picker head and arranged to rotate so that the picker head rotates to deliver the lid to the conveyer means. In one embodiment, rotation of the picker arm is implemented by way of a cam arrangement. It is an advantage of this embodiment to be able to deliver single lids to a labelling station quickly and rapidly, with minimum manual intervention. This advantageously keeps labelling costs to a minimum.

In accordance with a fifth aspect, the present invention provides a stacker apparatus for stacking drinks container lids which have been labelled with printed labels, the stacker apparatus including a magazine for receiving labelled lids, a stacker position, the stacker position being arranged to receive single lids from a conveyer means, and an impeller arrangement for impelling lids received at the stacker position into the stacker magazine.

The magazine in one embodiment is configured to arrange the lids in a stack formation.

In one embodiment, the impeller means is a jet of compressed air.

It is an advantage of an embodiment of the stacker apparatus to provide a stack of labelled lids for convenient handling and subsequent delivery.

In accordance with a sixth aspect, the present invention provides a labelling apparatus for labelling drinks container lids with printed labels, the apparatus including a delivery apparatus for delivering drinks container lids, the delivery apparatus including a picker arrangement arranged to pick single lids from a magazine and place them on a conveyer means for conveying the single lids to a labelling station, a labeller arranged to affix printed labels to each of the single lids, and a stacker apparatus arranged to receive the printed labels from the conveyer mechanism and stack the labels in a magazine.

The delivery apparatus in one embodiment is the delivery apparatus of the fourth aspect of the invention.

The stacker apparatus in one embodiment is the stacker apparatus of the fifth aspect of the invention.

It may be convenient to operate or license operation of a plurality of labelling apparatus such as discussed in the fifth aspect of the present invention, in order to promote to the public delivery of advertising (or promotions) via drinks container lids. It would be advantageous to be able to monitor operation of a plurality of labelling apparatus.

In accordance with a seventh aspect, the present invention provides a system for monitoring labelling apparatus for labelling drinks-cup lids with printed labels, the system including a monitoring means for monitoring a plurality of labelling apparatus to determine a quantity associated with the number of lids being labelled.

Advantageously, this quantity can be used to determine the production of the machines and the quantum of any license fee.

In one embodiment, the system includes a control means for controlling the plurality of apparatus. In one embodiment, the control means may be able to stop operation of the apparatus.

In one embodiment, the labelling apparatus is the labelling apparatus of the sixth aspect of the present invention.

In order to facilitate advertising campaigns, the present applicants have also invented a distribution system for distributing the lids with printed labels in an effective manner.

In accordance with an eighth aspect, the present invention provides a method of promotion via drinks outlets, comprising the steps of providing lids with printed labels including promotional or advertising information to the drinks container outlets at no cost, and receiving revenue for the lids from advertisers who have commissioned the promotional or advertising information on the printed labels.

Providing the lids to the drink outlets free is advantageously an incentive for the drink outlets to take the lids.

In one embodiment, a provider contracts to continue providing the lids free even where no printed labels with messages are on the lids.

In one embodiment, the drinks outlets are cafes, coffee shops, restaurants and the like who provide takeaway drinks, such as takeaway coffee, for example.

It is known to run “advertising campaigns” which may include the delivery of advertisements via more than one type of media. For example, via television and billboards. Such different media are quite diverse and may not be totally effective in bringing a promotional message across to the public.

In accordance with an ninth aspect, the present invention provides a method of delivering a campaign, comprising the steps of providing drinks container lids with printed labels including promotional or advertising information, and also providing an associated item including further promotional or advertising information associated with the same campaign.

In one embodiment, the associated item may include a drinks-cup which includes on the drinks-cup itself promotional or advertising information associated with the promotional or advertising information on the drinks-cup lid. By “associated”, is meant that the promotional or advertising information is related to the same promotion.

Other associated items in this embodiment may include a table top at the drinks outlet (providing a message on the table top), a tray (for example a printed sheet on a tray), an associated message on a stand-up holder on a table in the drinks outlet, an associated poster, and other items that may be placed conveniently at the drinks outlet.

In accordance with a tenth aspect, the present invention provides a method of monitoring labelling apparatus for labelling drinks-cup lids with printed labels, comprising the steps of monitoring a plurality of labelling apparatus to determine a quantity associated with the number of lids being labelled.

The method preferably includes the further step of utilising the quantity to determine a production of the labelling apparatus.

In accordance with an eleventh aspect, the present invention provides a method of delivering a campaign, comprising the steps of affixing the printed label in accordance with the third aspect of the present invention, to a drinks container lid of the type which is arranged to fit over the mouth of a cup-type container.

In accordance with a twelfth aspect, the present invention provides a labelling apparatus for labelling drinks container lids with printed labels, the apparatus including registration means arranged to facilitate placement of the printed labels on the lids in a predetermined orientation.

In one embodiment, the predetermined orientation relates to printed matter presented on the lids, so that the printed matter is positioned in substantially the same orientation with respect to the lid for each lid that is labelled.

In one embodiment, the drinks container lid is of the type which has a passageway, spout or other exit which enables fluid to pass through e.g. to be imbibed by a consumer. In this embodiment, the orientation of the label is such that a consumer drinking from the passageway, spout or exit would be easily able to view the printed matter. Where that the printed matter includes wording, the user is preferably able to read the wording. In one embodiment, the wording may be placed at “twelve o'clock” to the spout, exit or passageway.

### BRIEF DESCRIPTION OF THE DRAWINGS

Features and advantages of the present invention will become apparent from the following description of embodiments thereof, by way of example only, with reference to the accompanying drawings, in which:

FIG. 1(a), (b), (c) are printed labels for drinks container lids, in accordance with an embodiment of the invention; FIG. 1(d) is a diagram of a printed label with a removable section, in accordance with an embodiment of the present invention;

FIG. 2 is a perspective view from above and one side of a labelling apparatus in accordance with an embodiment of the present invention;

FIG. 3 is a view from one side of the labelling apparatus of FIG. 2;

FIG. 4(a), (b), (c) are perspective views of a delivery apparatus in accordance with an embodiment of the present invention;

FIG. 5 is a perspective view from one side of a part of the delivery apparatus of FIG. 4;

FIG. 6 is a sectional view from one side of a stacker apparatus in accordance with an embodiment of the present invention;

FIG. 7 is a perspective view from above and one side of the stacker apparatus of FIG. 6;

FIG. 8 is a perspective view from above and behind of the delivery apparatus of FIG. 4;

FIG. 9(a), (b), (c) are views from behind of the delivery apparatus of FIG. 4;

FIG. 10 is a plan view of a coffee lid utilised in accordance with an embodiment of the present invention;

FIG. 11 is a perspective view of the coffee lid of FIG. 10;

FIG. 12 is a block diagram illustrating a distribution system in accordance with an embodiment of the present invention;

FIG. 13 is a schematic diagram of a monitoring system for monitoring labelling apparatus, in accordance with an embodiment of the present invention;

FIG. 14 is a plan view of a detail of the apparatus of FIG. 2, illustrating means for registration of container lids; and

FIG. 15 is a perspective view from one side of the apparatus of FIG. 14.

### DETAILED DESCRIPTION OF PREFERRED EMBODIMENTS

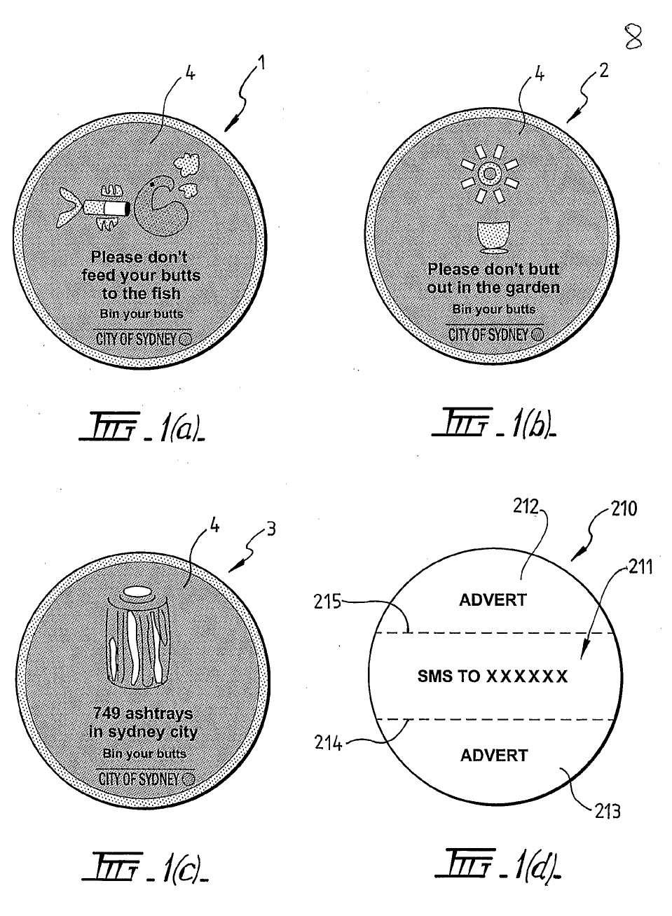

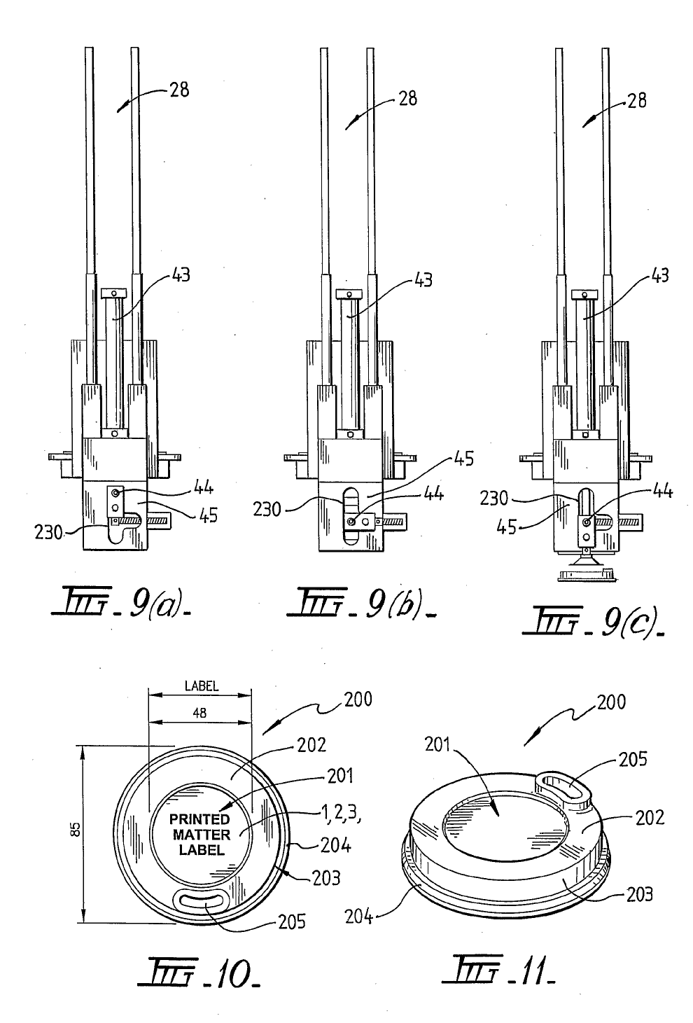

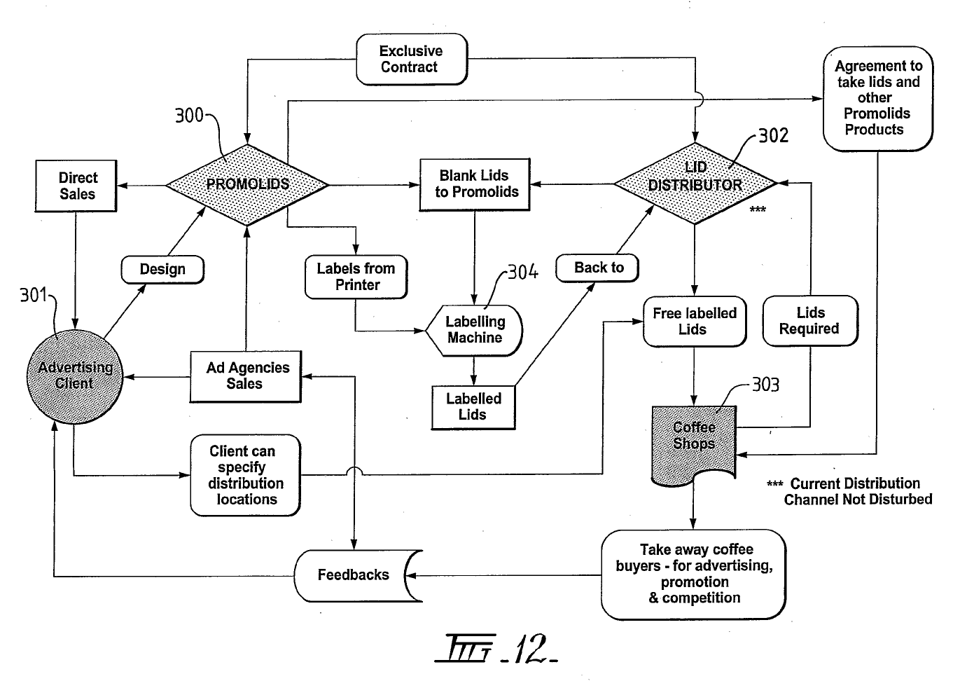

FIG. 1 illustrates three actual-size printed labels for use on drinks container lids, in accordance with an embodiment with the present invention. In these examples, the labels 1, 2, 3 are intended for use on takeaway coffee container lids. These types of lids (see FIGS. 10 and 11) and generally comprise plastics or paper lids 200 having a top surface 201, which in some cases may have a raised area 202 around the outside, and a skirt 203 depending from the top area with a lip 204 which is arranged to fit to the mouth of the drinks container lid (usually over the mouth of the drinks container lid). The lid may include a spout 205 or hole in the top surface of the lid through which a consumer can imbibe drink. The printed labels in accordance with this embodiment of the invention are arranged to adhere to the top surface 201 of such a drinks container lid. In this example, adhesive is applied to the back surface of the label 1, 2, 3, to adhere to the drinks-container lid.

As is clearly illustrated in FIG. 1(a), (b), (c) promotional or advertising information is printed on the top surface 4 of the printed label 1, 2, 3. In this example, various messages relating to an anti-litter campaign against cigarettes are illustrated. Any promotion or advertisement information may appear on the printed labels.

Providing such labels on drinks container lids, such as coffee cup lids, is believed to be an extremely effective way of delivering messages to the public, having high impact. The message is delivered, on the top of the coffee or other drinks-cup lid, very close to the person (a very short distance away from them when they are drinking the drink, usually via an opening in the top of the drinks-container lid). Even if they remove the lid after they have obtained their takeaway drink, they will have had plenty of opportunity to view the message.

FIG. 1(d) shows, in diagrammatic form, another example of a printed label in accordance with an embodiment of the present invention. This embodiment 210, includes a removable section 211. The removable section may be used to promote a competition, for example, or to include other information that the user may remove from the label and drinks container lid. In this embodiment, the label comprises three sections. Sections 212 and 213 (upper and bottom sections) have adhesive on their back surfaces so they adhere to the drinks container lid. The top surface may be printed with information such as advertisements. The central section 211 does not have adhesive on its rear surface. It is connected to the upper 212 and bottom 213 sections by perforated lines 214, 215. It can therefore be torn away from the upper and bottom sections and removed from the drinks container lid. It may contain information such as (as shown in this example) to instruct the user to send an SMS message in order to enter a competition.

As discussed above, prior art lids have been moulded to include some wording. This requires a new moulding for every message to be delivered and does not provide the sophisticated graphics and versatility of a printed label.

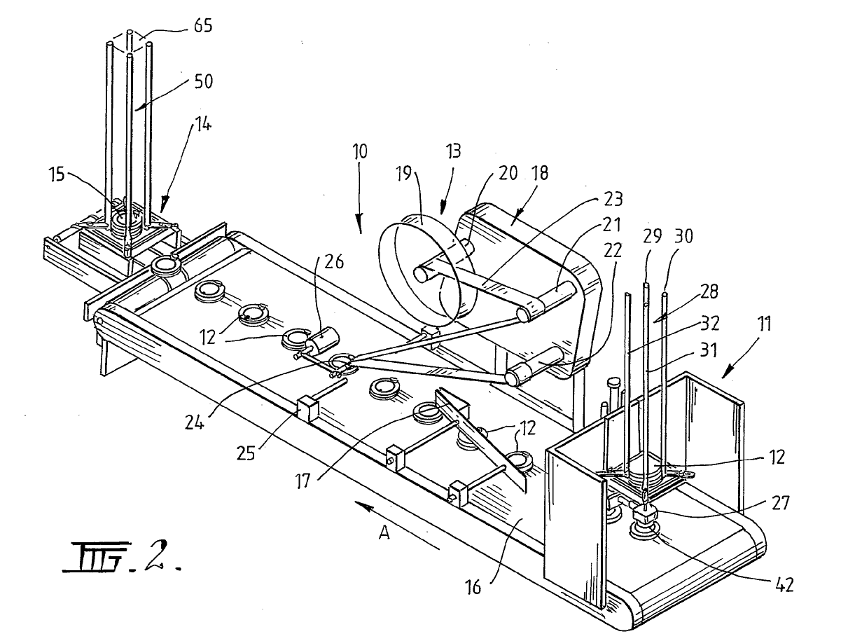

One of the issues with the prior art moulded lids was cost. In order to provide lids in accordance with an embodiment of the present invention it is necessary to affix the labels to the lids. The applicants have developed an apparatus which implements a process of affixing labels to lids in a cost effective manner. The apparatus will now be described with reference to FIGS. 2-9.

A labelling apparatus in accordance with an embodiment of the present invention is generally designated by reference numeral 10. The labelling apparatus comprises a delivery apparatus 11 which is arranged to deliver drinks-cup lids 12 to a labelling station 13. It also comprises a stacker apparatus 14, which is arranged to receive labelled lids 12 and stack them in a convenient to handle stack 15.

In more detail, the delivery apparatus 11 delivers single lids 12 sequentially onto a conveyer 16 which is running in the direction shown by arrow A. The lids 12 move with the conveyer towards the labelling station 13 and are guided by a guide 17 to ensure that they are in the right location for labelling. The labelling station 13 comprises a labeller 18 which includes a roll 19 of printed labels to be affixed to the lids 12. The roll is mounted for rotation on an axle 20 and spindles 21, 22 guide a tape 23 mounting the printed labels from the roll to a delivery point 24. The labeller 18 is of known type. An infrared sensor 25 detects the position of the lid 12 and activates the labeller 18 to place a label on the drinks-cup lid 12. A sponge roller 26 is arranged to secure the label on the drinks-cup lid as the drinks-cup lid 12 passes under the roller 26.

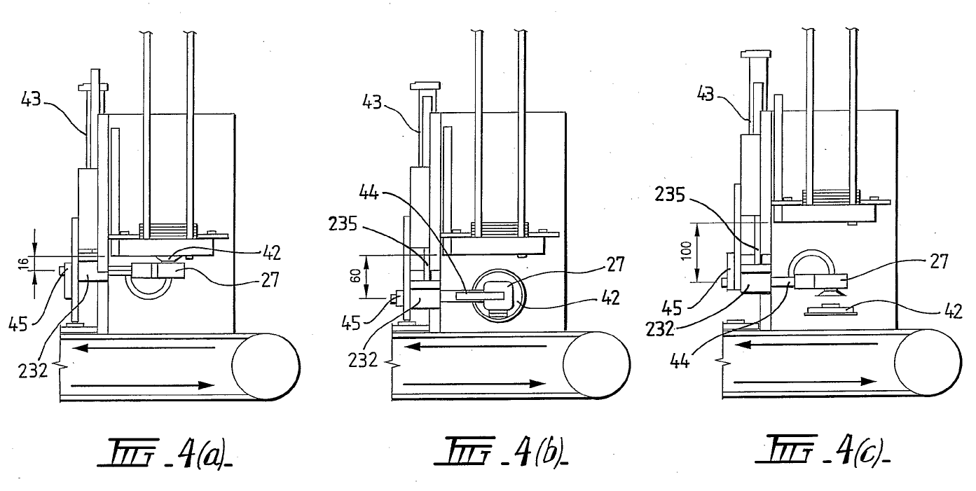

In order to ensure sufficient throughput with minimal manual intervention (and therefore low cost) single lids are placed on the conveyer 12 sequentially at intervals by, in this embodiment, a delivery apparatus 11 including a picker arrangement 27 which will be now described in more detail and in particular with reference to FIG. 4(a)(b)(c) and 9(a)(b)(c).

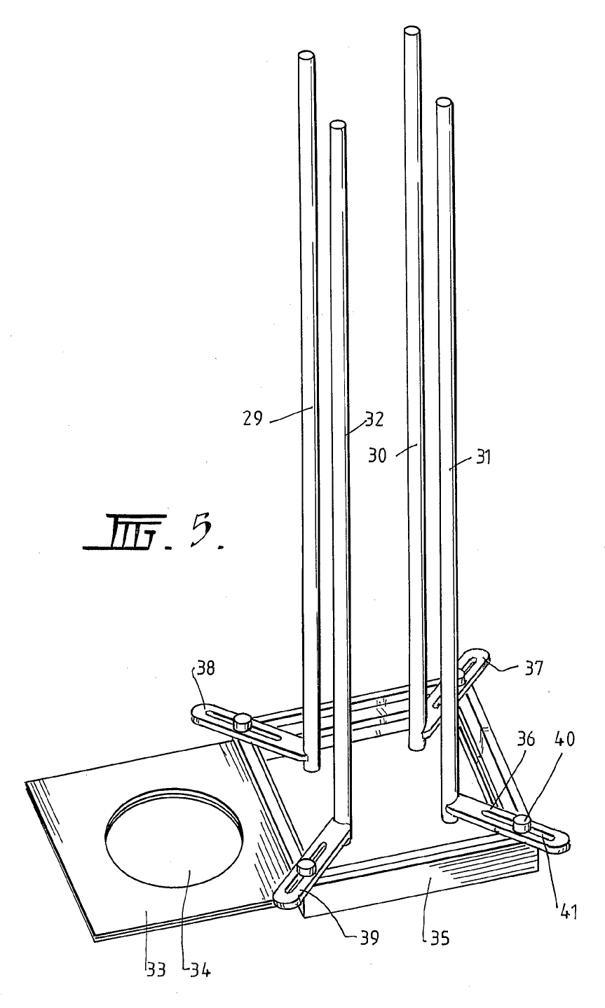

The delivery apparatus 11 includes a magazine 28, which in this embodiment includes four upstanding rods 29, 30, 31, 32, which are positioned to receive a stack of lids 12 for delivery to the labelling station 13. The lids 12 are fed by way of a dye 33 (FIG. 5), which defines a hole 34 corresponding to the size of the lids 12. It can be seen from FIG. 5 that the magazine comprises a frame 35 supporting the rods 29, 30, 31, 32. Note that in FIG. 5 the dye 33 is shown removed from the frame 35, and in use sits within the frame 35. Note also from FIG. 5 that the rods are mounted on adjustable mounts 36, 37, 38, 39 which are adjustable to enable the rods to be moved inwards or outwards to vary the size of the magazine to take different sized lids (similarly with the dye 33). The adjustable mounts 36, 37, 38, 39 work on a simple screw 40 and slide 41 arrangement in each case. Adjustment of the screw 40 relieves tension on the mount 36, 37, 38, 39 so that the screw 40 can move relative to the slide 41 to adjust the position of the rod.

Referring in particular to FIG. 4, the delivery apparatus 11 includes a picker arrangement 27. The picker arrangement 27 includes a grabber 42 which, in this example, is in the form of a suction cup. Powered by a compressed air driver 43 (linked to compressed air line, not shown), the suction cup 42 grabs a lid 12 from the magazine 28 (FIG. 4a) removes it from the magazine 28, and, rotating through 180° (FIG. 4b) places the lid 12 on the conveyer 16 and releases it (FIG. 4c). The picker arrangement 27 then repeats this operation and will continue until the lids 12 run out from the magazine 28 or the machine is switched off.

One of the problems with delivery of plastics and paper and other types of drinks container lids is that they are light, so that gravity feed to the conveyer is difficult if not impossible. They must be placed. Placing without manual intervention is difficult, and the picker arrangement 27 addresses this issue. The picker arrangement 27 includes a picker arm 44 which rotates to rotate the picker head 42 and moves downwards to place the lid 12 on to the conveyer. The picker arm is rotated by a cam arrangement 45, which enables the arm 44 and head 42 to be rotated quickly under the power of the compressed air driver 43. The picker arrangement can therefore operate rapidly and consistently to put in place drinks-cup lids 12 on the conveyer 16.

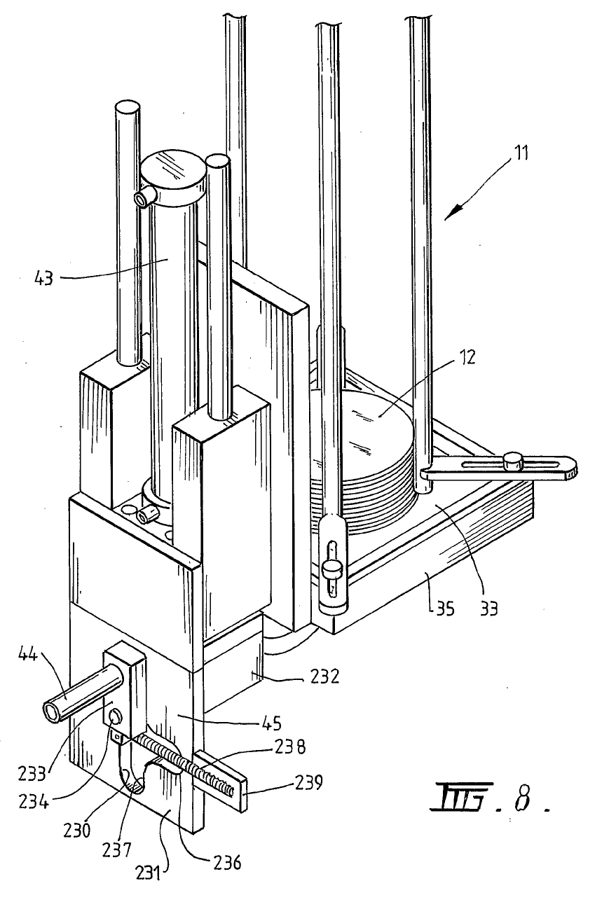

FIG. 9(a),(b),(c) show views which are of an operation of the cam arrangement. FIG. 8 also shows a detail illustration of the cam arrangement. The cam arrangement comprises a guide 230 in the form of a slot in a frame 231 at a back end of the delivery apparatus 11. The picker arm 44 is mounted for rotation within a movable mounting 232. The picker arm 44 extends through the mounting 232 out the back thereof and through a cam block 233. The cam block is mounted on a bearing 234 for movement within the guide 230. The picker arm 44 forms a hollow shaft through which compressed air can be provided to the grabber 42. A compressed air hose (not shown) is connected to the picker arm 44. A piston 235 is arranged to actuate the mounting 232 and move it downwardly in accordance with operation of the air driver 43. The movement downwardly of the movable mounting 232 also causes the picker arm 44 to move downwardly, removing the lid 12 from the magazine 28.

The guide 230 includes a horizontal section 236 half way down the longitudinal section 237 of the guide. A spring 238 is mounted with one end secured to a projecting portion 239 of the frame 231 and the other end secured to the bearing 234 or bottom surface of the cam block 233.

In operation, as the picker arm moves downwards, the bearing 234 at first remains in the longitudinal portion of the guide 237. When it reaches the horizontal portion of the guide 236, however, the spring 238 causes the bearing to move into the horizontal portion of the guide 236. The cam block therefore rotates through 90° (FIG. 9(b). On further motion downwards of the picker arm 44, the cam block 233 continues its rotation to 180° (FIG. 9(c). The picker head 42 is then in a position to place the lid 12 on the conveyer 16.

When the movable mounting 232 is moved upwards by the piston 235 in response to the air driver 43, motion of the cam block 233, picker arm 44 and picker head 27 is reversed.

Note that this cam arrangement is not the only arrangement which could impart the appropriate motion to the picker head. Other arrangements could potentially be used. For example, it may be possible to utilise a rack and pinion (the pinion being attached to rotate the picker arm 44) of appropriate size and dimensions.

Without such an arrangement, it is believed that the provision of drinks-cup lids with printed labels on them would be much more difficult and expensive. The picker arrangement 27 facilitates production of labelled lids 12 at such rates as to lower cost and make promotions using messages printed on the labels cost-effective.

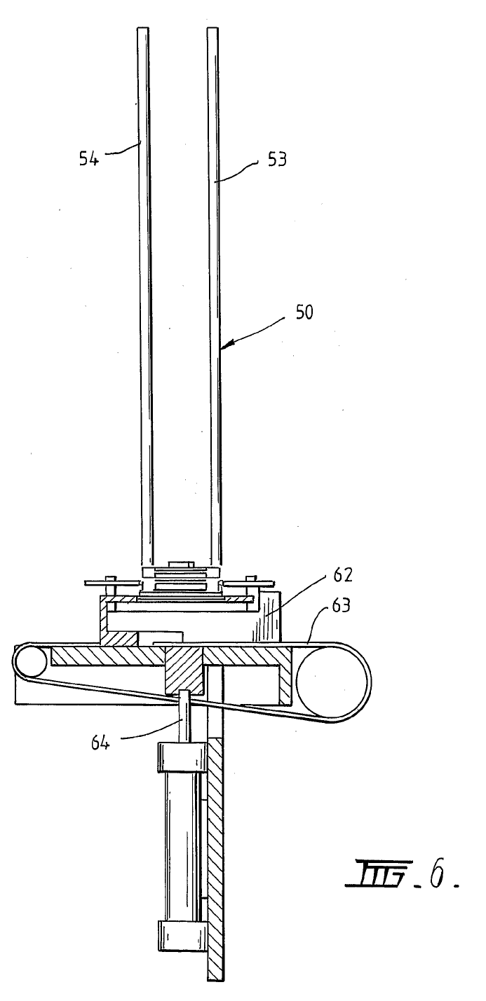

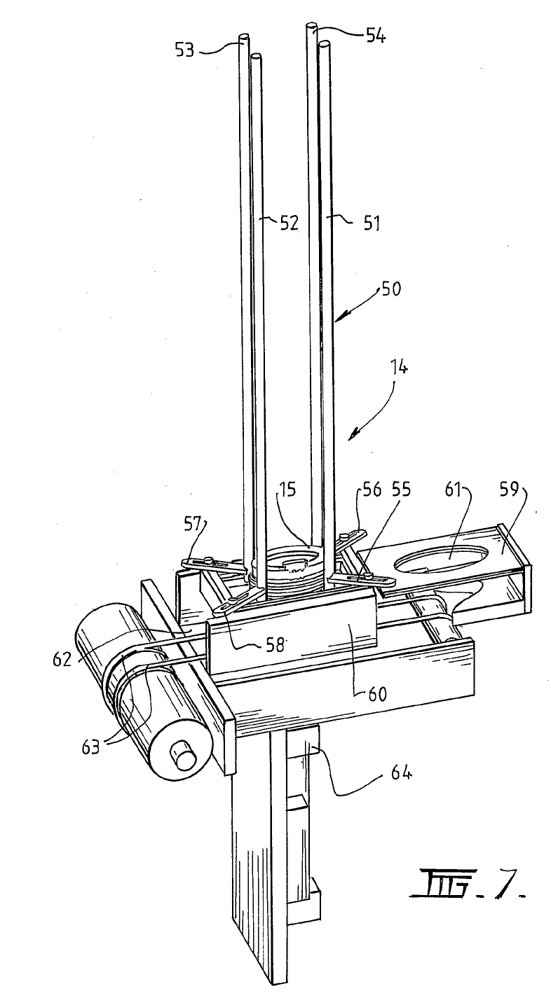

Referring again to FIG. 2, when the label lids 12 have passed the roller 26 they are conveyed by conveyer 16 to stacker apparatus 14. Referring to FIGS. 6 and 7 in particular, stacker apparatus 14 includes a magazine 50 which is similar in construction to the magazine 28 of the feeder apparatus 11. The magazine 50 includes four rods 51, 52, 53, 54, which are mounted on similar adjustable mounts 55, 56, 57, 58. The magazine 50 is thus adjustable in size so that it can receive drinks container lids of different dimensions. A template 59 sits within a frame 60 of the magazine and defines a hole 61 therein for receiving therethrough drinks container lids into the magazine 50. The template 59 can be removed and replaced with templates of different sizes (with different sized holes) for different sized drinks-container lids.

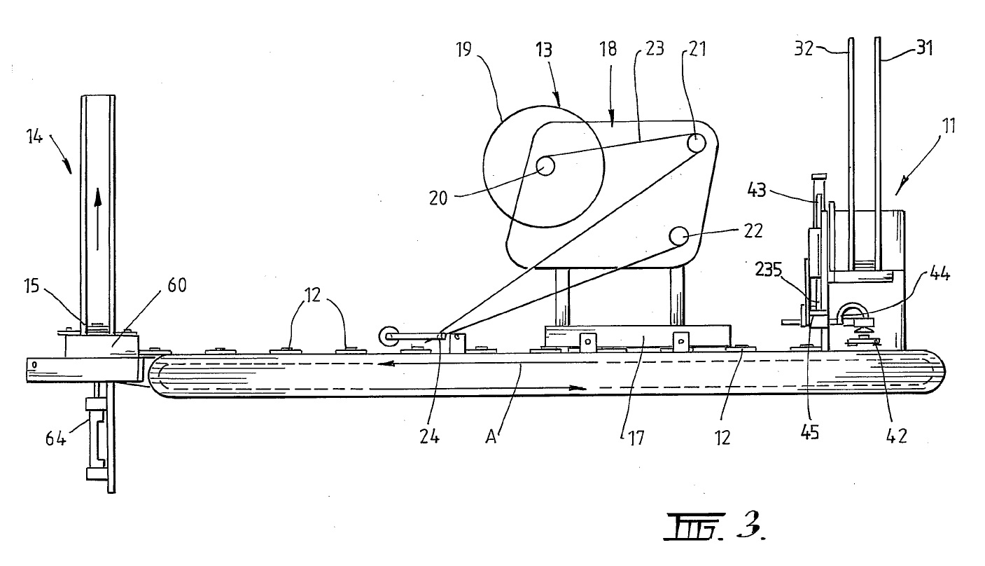

When lids 12 approach the stacker apparatus 14, they enter the stacker apparatus at a gate 62 defined by the frame 60. A further conveyer mechanism 63 conveys the lids 12 into the gate and to a position under the magazine 50. When a lid reaches the position as detected by an infrared sensor (not shown) an air driver 64, powered by compressed air) is activated to impel the lid 12 into the magazine 50. A stack 15 of lids 12 with printed labels is eventually built up in the magazine 50. Referring to FIGS. 2 and 3, a stack package 65 is supported by rods 51, 52, 53, 54. When the stack 15 is built up to the top of the rods, the stack package 65 and stack 15 can be removed as one for distribution to outlets.

At the delivery apparatus 11 more lids 12 can be placed in the magazine 28 before a previous load of lids is used. The apparatus can thus operate continuously to provide high productivity of lids with printed labels on them.

Because the placement of the lids on the conveyer 16 is automated it can be seen (see FIG. 20) that the lids are placed on the conveyer in the same orientation. In the example shown in FIG. 2, the “spout” of each lid 12 is directed towards the right side of a conveyer. This has the advantage that the printed labels are placed in the same orientation as each lid. Information presented by the labels can therefore be positioned with a predetermined orientation e.g. to ensure that the user is able to read the information.

Further, in order to ensure that the same orientation is maintained for the label/lid combination, the speed of the conveyer 16 and tape 23 have to be synchronised so that lids arrive at the right time to be labelled. This is done utilising a stepper motor and appropriate software to minimise friction while placing the label on the lid (so as not to move the lid out of orientation).

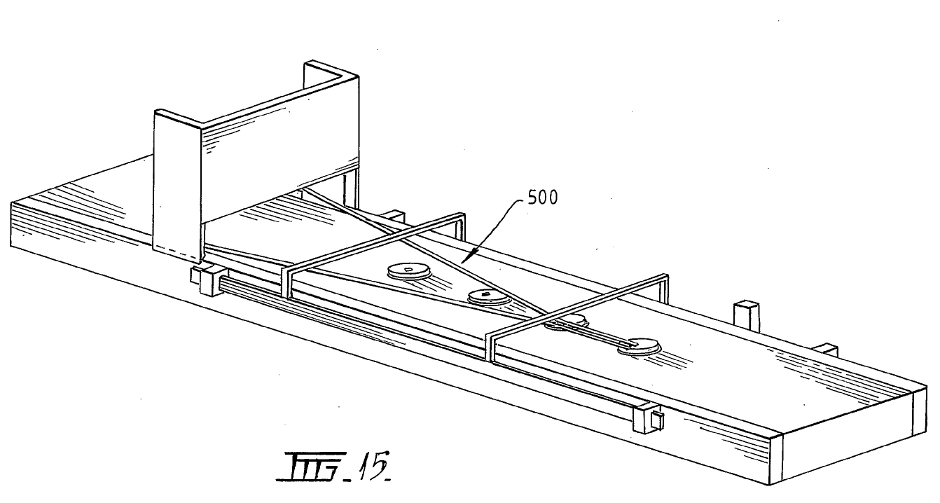

In addition, a registration device, indicated by reference numeral 500 in FIGS. 14 and 15 is used to facilitate consistent orientation of the drinks container lids so that when a label is placed on the drinks container lid, the label will be in the same respective orientation. In the preferred embodiment, the label is in an orientation such that any text is at “twelve o'clock” to the spout, as indicated in the example of FIG. 10. When a user is drinking from the spout, they will therefore be easily able to read any text on the label.

Referring to FIGS. 14 and 15, the registration device in this embodiment comprises a pair of rods 501, 502 which converge to a relatively narrow distance at the printing station 503. The rods serve to capture and guide a spout 504 of the drinks container lid so that the drinks container lid is always in the same orientation at the labelling station. Combined with the infra-red receiver 25 and transmitter 506, which activates labelling (the labelling head is activated when the lid breaks the beam), and combined with the synchronisation of the conveyer and tape, this facilitates labelling in the correct orientation.

Note that other registration devices may be utilised and the present invention is not limited to the registration device of the type 500.

The registration device 500 and infra-red receiver and transmitter arrangement also assist with ensuring that the label is placed in position in the central portion of the device. This is particularly important where the drinks lid is of the type having a raised rim and depressed central portion. It is difficult to ensure that the label is placed correctly. For example, it would be very difficult to do in a repetitive manual process. Having the transmitter and receiver arrangement and registration device facilitates positioning of the lid to receive the label.

The present applicants have devised a novel distribution strategy for delivering lids with printed labels in accordance with the present invention.

It is intended that lids will be utilised at drinks container outlets such as cafes, restaurants, takeaway food and drinks outlets. In order to ensure continuing market take-up, lids will be offered to the outlet owners for no cost. Presently, there is a cost to café owners, of for example, coffee cup lids. Offering the lids at no cost is an incentive to being included in whatever promotional campaign is being delivered by the message information on the labels.

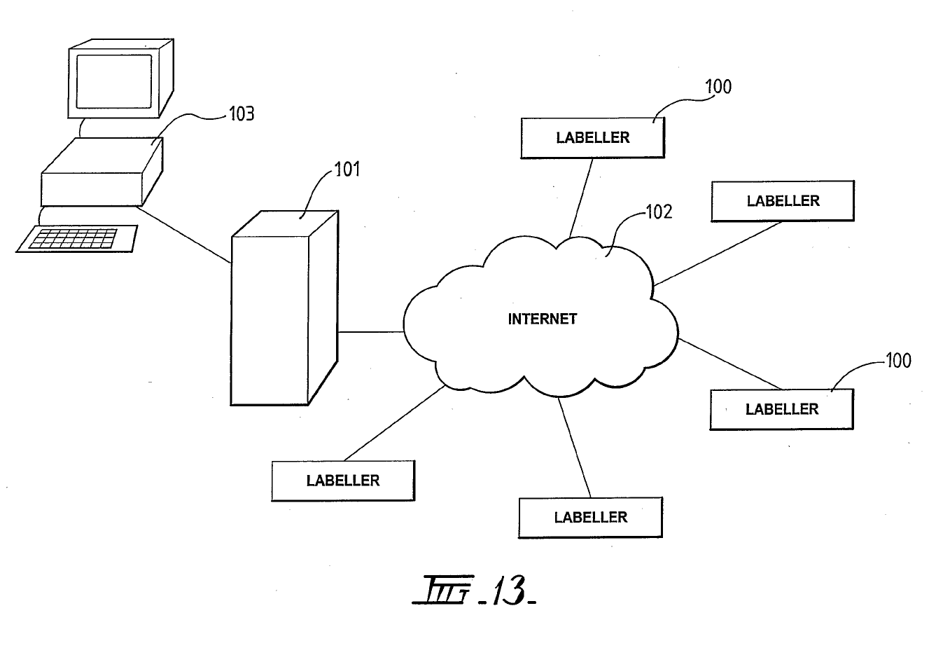

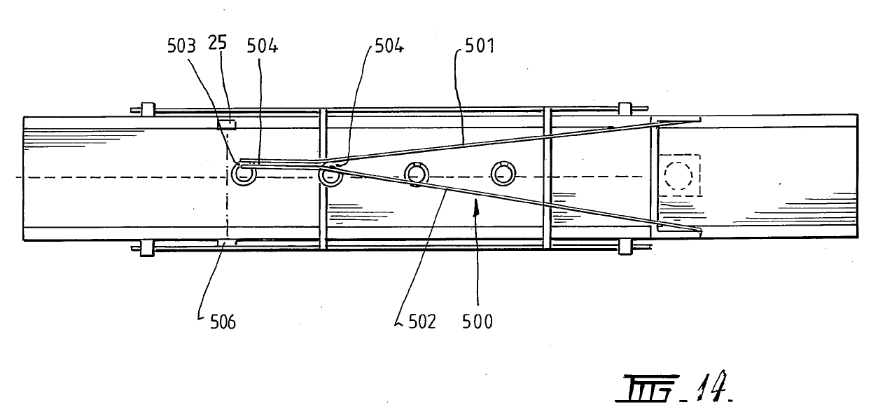

In operation, a lid marketer (reference numeral 300, FIG. 12) will market the lids to advertisers 301 who may wish promotional messages to be placed on the lids. A lid provider 302 markets the lids to outlet 303 owners (the marketer and provider may be a single entity or separate entities), such as coffee shops. Marketer 300 will arrange for messages to be included on printed labels, as dictated by advertisers. Lids with the printed labels on them are then produced using the apparatus discussed above 304, and delivered to the drink container outlets 303.

Any promotional campaign can be neatly geographically targeted as locations of the outlets will be known. Marketing information can also be fed back to the advertisers, from the particular localities.

Promotional campaigns can be delivered on more than one item (not just the drinks container lids). Associated items may include other items in the café, such as café tables, posters in the cafes, menus (or any other item in an outlet). Similar or complementary information can be included on such associated items to implement a “saturation” campaign in particular targeted outlets.

Other items may include a takeaway tray for the use of carrying takeaway coffee containers. A pen which may include advertising messages on it.

In a variation to the distribution system, the café or other outlet owner may be paid to implement an advertising campaign. That is, they would receive their coffee cups and coffee containers essentially free, and may even make a profit out of the arrangement.

One possible business model for operating the labelling apparatus is to have a plurality of franchisees, each operating one or more labelling apparatus. With reference to FIG. 8, a system is shown for monitoring output of labelling apparatus.

Labelling apparatus 100, such as the labelling apparatus described above in relation to FIGS. 2 to 7, includes counters which count the number of lids that are labelled (or a quantity associated with the number of lids labelled). The labelling apparatus include processing means networked to a control unit 101 via a network such as the Internet 102. An operator one of the control apparatus 101 (which may be a server computer) via a control unit (which may be a PC 103 networked to the control unit 101) can therefore monitor the number of lids (or associated quantity) that each labeller 100 is producing. They can use this information to exert control over the franchisees.

In this embodiment, the control unit 101 is also arranged to be able to control an “off” switch of the labeller apparatus 100. If franchisees are not conforming with requirements, an operator at PC 103 can cause the control unit 101 to switch off a particular labeller 100.

The lids of the present invention may be any drinks-container lid for example, coffee, cocoa, fizzy drink, etc. The drinks container lid may be provided at any outlet, e.g. vending machine drinks, cafes, fast food outlets, etc.

The drinks container lid need not be exactly as shown in the drawings as described above, but may include any drinks container lid for covering the mouth of a takeaway container cup.

Note that where the term “printed label” is used, it is not limited to labels which only carry matter that has been printed thereon. Labels which have images or text or other devices which have been provided by other means than printing as such also fall within the scope of the present invention under the term “printed label”.

Note that the delivery apparatus magazine forming a stack of lids in the above-described embodiment, may be of a different form. It may comprise a feeder bowl, for example, arrange to feed lids to the picker head.

Modifications and variations as would be apparent to a skilled addressee are deemed to be within the scope of the present invention.

1. A method for delivering promotion or advertising, comprising the steps of providing a drinks container lid having a printed label on the top surface thereof, the printed label bearing promotional or advertising information, the printed label having been affixed by a labelling apparatus to the lid, in a predetermined orientation of the promotional or advertising information with respect to the lid.

2. A method in accordance with claim 1, wherein the drinks container lid is the type of lid arranged to fit to the mouth of a cup-type container.

3. A method in accordance with claim 1, wherein the printed label is circular and covers substantially a central portion of the drinks container lid.

4. A method in accordance with claim 3, wherein the lid includes a central portion and a raised rim portion, and the printed label is mounted in the central portion.

5. A method in accordance with claim 4, wherein the printed label covers substantially the entire central portion.

6. A method in accordance with claim 1, wherein the printed label covers 50% or greater of the top surface of the drinks container lid.

7. A method in accordance with any claim 1, wherein the label includes a removable section.

8. A method in accordance with claim 1, wherein the lid is a lid for a takeaway coffee cup.

9. A method in accordance with claim 1, including the further step of providing a plurality of the drinks container lids for a promotional or advertising campaign.

10. A method in accordance with claim 8, wherein the printed label is placed in the same orientation on each lid for each of the plurality of lids.

11. A device for delivering a message, the device comprising a drinks container lid having a printed label on the top surface thereof, which bears promotional or advertising information, the printed label having been affixed to the lid by a labelling apparatus, in a predetermined orientation of the promotional or advertising information with respect to the lid.

12. A device in accordance with claim 11, wherein the drinks container lid is of the type which fits to the mouth of a cup-type container.

13. A device in accordance with claim 11, wherein the printed label is circular and covers substantially the central portion of the lid.

14. A device in accordance with claim 13, wherein the lid is of the type having raised rim portion and a central portion, and the printed label covers substantially the entire central portion

15. A device in accordance with claim 11, wherein the printed label is of a size which covers 50% or more of the top surface of the drinks container lid.

16. A printed label for a drinks container lid, the printed label being arranged to be affixed to the top of the drinks container lid, and the printed label bearing promotional or advertising material.

17. A printed label in accordance with claim 16, arranged to be affixed to the type of drinks container lid which fits to the mouth of a cup-type container.

18. A printed label in accordance with claim 17 being circular in form.

19. A printed label in accordance with claim 18, arranged to cover a central portion of the drinks container lid.

20. A printed label in accordance with claim 19, wherein the drinks container lid is of the type having a raised rim about a central portion, and the printed label is arranged to substantially cover the central portion.

21. A printed label in accordance with claim 16, arranged to cover 50% or more of the top surface of the drinks container lid.

22. A method of delivering a campaign, comprising the steps of affixing the printed label in accordance with claim 16, to a drinks container lid of the type which is arranged to fit over the mouth of a cup-type container.

23. A method in accordance with claim 22, wherein the drinks container lid includes a central portion and a raised rim portion, and the step of affixing the printed label to the lid includes the step of affixing the printed label to the central portion of the lid.

24. A method in accordance with claim 22, wherein the step of affixing the printed label includes the step of affixing the printed label in a predetermined orientation.

25. A method in accordance with claim 22, wherein the step of affixing the printed label is carried out by a labelling apparatus.

26. A delivery apparatus for delivering drinks container lids to a labelling station for labelling with printed labels, the delivery apparatus including a picker arrangement arranged to carry out an operation involving picking a single lid from a magazine arranged to contain a plurality of lids and placing the lid on a conveyer means for conveying the lid to the labelling station, the picker arrangement being arranged to carry out the operation repetitively to continue to place single lids on the conveyer means.

27. A delivery apparatus in accordance with claim 26, wherein the picker arrangement includes a picker head, arranged to grab a lid from the magazine, and a picker arm attached to the picker head and arranged to rotate so that the picker head rotates to deliver the lid to the conveyer means.

28. A delivery apparatus in accordance with claim 27, further including a cam arrangement for implementing rotation of the picker arm.

29. A delivery apparatus in accordance with claim 28, wherein the cam arrangement includes a guide and a bearing moving within the guide, the guide having a vertical and horizontal portion, the bearing moving, in operation, down the horizontal portion and then into the vertical portion and back out of the horizontal portion, resulting in rotation of the picker am.

30. A delivery apparatus in accordance with claim 26, wherein the drinks container lid is of the type which is arranged to fit to the mouth of a cup-type container.

31. A delivery apparatus in accordance with claim 30, wherein the drinks container lid has a central portion and a raised rim portion.

32. A stacker apparatus for stacking drink container lids which have been labelled with printed labels, the stacker apparatus including a magazine for receiving labelled lids, a stacker position, the stacker position being arranged to receive single lids from a conveyer means, and an impeller arrangement for impelling lids received at the stacker position into the stacker magazine.

33. A labelling apparatus for labelling drinks container lids with printed labels, the apparatus including a delivery apparatus for delivering drinks container lids, the delivery apparatus including a picker arrangement arranged to pick single lids from a magazine and place them on a conveyer means for conveying the single lids to a labelling station, a labeller arranged to affix printed labels to each of the single lids, and a stacker apparatus arranged to receive the printed labels from the conveyer mechanism and stack the labels in a magazine.

34. A labelling apparatus in accordance with claim 33, wherein the stacker apparatus is the stacker apparatus of claim 32.

35. A labelling apparatus in accordance with claim 33, wherein the delivery apparatus is the delivery apparatus comprises a picker arrangement arranged to carry out an operation involving picking a single lid from a magazine arranged to contain a plurality of lids and placing the lid on a conveyer means for conveying the lid to the labelling station, the picker arrangement being arranged to carry out the operation repetitively to continue to place single lids on the conveyer means.

36. A system for monitoring labelling apparatus for labelling drinks-cup lids with printed labels, the system including a monitoring means for monitoring a plurality of labelling apparatus to determine a quantity associated with the number of lids being labelled.

37. A system in accordance with claim 36, wherein the monitoring means includes a controller which is arranged by way of network connection to communicate with the plurality of labelling apparatus, which may be in remote locations.

38. A system in accordance with claim 37, wherein the controller is arranged to provide instructions for turning off one or more of the plurality of labelling apparatus.

39. A method of promotion via drinks outlets, comprising the steps of providing lids with printed labels including promotional or advertising information to the drinks container outlets at no cost, and receiving revenue for the lids from advertisers who have commissioned the promotional or advertising information on the printed labels.

40. A method of delivering a campaign, comprising the steps of providing drinks container lids with printed labels including promotional or advertising information, and also providing an associated item including further promotional or advertising information associated with the same campaign.

41. A method in accordance with claim 40, wherein the associated item may include one or more of the following:
drinks container,
tray for carrying drinks container,
poster,
tabletop,
menu;
sugar pouch;
pen.

42. A method in accordance with claim 40, wherein the drinks container lid is of a type which is arranged to fit to a mouth of a cup-type drinks container.

43. A method in accordance with claim 40, wherein the step of providing a drinks container lid is carried out at a drinks outlet.

44. A method in accordance with claim 43, wherein the drinks outlet is a cafe or coffee shop selling takeaway coffee.

45. A method of monitoring labelling apparatus for labelling drinks-cup lids with printed labels, comprising the steps of monitoring a plurality of labelling apparatus to determine a quantity associated with the number of lids being labelled.

46. A labelling apparatus for labelling drinks container lids with printed labels, the apparatus including registration means arranged to facilitate placement of the printed labels on the lids in a predetermined orientation.

47. An apparatus in accordance with claim 46, wherein the drinks container lid is of the type which has a passageway, spout or other exit, which enables a fluid to pass through, and wherein the orientation of the label is such that a consumer drinking from the passageway, spout or other exit would be easily able to view any printed matter on the label.

48. An apparatus in accordance with claim 47, wherein the printed matter includes text and the orientation is such that a user would be able to easily view the text.

49. An apparatus in accordance with claim 46, wherein the registration means includes a registration device which is arranged to position the lid so that it is positioned in the correct orientation at a labelling station.

50. An apparatus in accordance with claim 49, wherein the lids are of the type which includes a spout, and the registration device is arranged to physically interfere with the spout to orientate the lid.

51. A labelling apparatus in accordance with claim 46, the registration means including a sensor to sense the position of the lid.

52. A labelling apparatus for labelling drinks container lids with printed labels, the apparatus including means for ensuring that the label is placed in the correct position on the lid.

53. An apparatus in accordance with claim 52, wherein the lid is of the type having a raised rim portion and lowered central portion, and the means ensures that the label is placed on the lower central portion.

54. An apparatus in accordance with claim 52, wherein the means comprises a sensor.
